(19) United States
(12) Patent Application Publication
(10) Pub. No.: US 2019/0338119 A1
(43) Pub. Date: Nov. 7, 2019

(54) RESIN COMPOSITION FOR BONDING METAL, PRODUCTION FORMED BY BONDING METAL WITH RESIN COMPOSITION, AND MANUFACTURING METHOD THEREOF

(71) Applicant: Toray Industries, Inc., Tokyo (JP)

(72) Inventors: Xingchao Qi, Shanghai (CN); Dapeng Zheng, Shanghai (CN); Xianwen Tang, Shanghai (CN); Koya Kato, Shanghai (CN); Masashi Matsuda, Guangdong (CN); Xinpu Zhang, Guangdong (CN)

(21) Appl. No.: 16/470,857

(22) PCT Filed: Dec. 26, 2017
(86) PCT No.: PCT/CN2017/118442

§ 371 Date: Jun. 18, 2019

(30) Foreign Application Priority Data
Dec. 28, 2016 (CN) 201611232795.4
Aug. 14, 2017 (CN) 201710690782.X

(51) Int. Cl. C08L 71/12; C08J 5/12; C08L 81/04

(52) U.S. Cl. CPC C08L 71/12; C08J 5/121; C08L 81/04; C08L 2205/03; C08J 2371/10; B29C 45/14; C08J 2381/04; C08J 2481/04; C08J 2479/08; C08J 2481/06; C08J 2471/10

(57) ABSTRACT

A composition is composed mainly of: a component (I) (which is at least one selected from polyether ketone, polyether ether ketone, and polyether ketone ketone); a component (II) (which is polyphenylene sulfide); and, additionally if necessary, a component (III) (which is at least one selected from polyether imide, polyimide, polyamide imide, and polysulfone resins) and (IV) an inorganic filler. The composition is obtained using a conventional melt-kneading machine, for example, a single screw or twin screw extruder, Banbury mixer, or kneader in accordance with the melt-kneading method corresponding to the kneading machine. The resin composition for metal bonding has excellent metal bonding properties, and is applicable for use in automobile parts that require the composition to be bonded with metal and in electronic products such as laptop computers and mobile phones.

### TECHNICAL FIELD

This disclosure relates to the field of high molecular weight polymer materials, and relates mainly to a resin composition for bonding metal, a molded article of the resin composition bonded with metal, and a method of producing the same.

### BACKGROUND

In recent years, there has been a day-by-day increasing demand for weight saving in automobiles, and one effective countermeasure is to promote replacement of original materials by materials having a small density and a light mass such as aluminum, magnesium, titanium alloys, resins, and composite materials. In addition, the advent of a new power unit has brought about a significant increase in the usage amount of steel, aluminum materials, copper materials and the like that are used as the main materials for such a new power unit. In response to such a situation, there is a gradual increase in demand for a technology to bond different kinds of related materials together, and focus is on a new technology to bond different kinds of materials using resins as the main materials.

Conventional metal-resin bonding technologies mainly involve treatment of the surface of metal with a chemical reagent or irradiation of the surface with a laser (WO2004/041532 and WO2013/077277), and metal-bonded resin compositions used for those technologies are polyphenylene sulfide compositions, polybutylene terephthalate compositions, polyamide compositions and the like.

Among conventional technologies, there is also a method of producing composite materials in which CFRTP and a resin are bonded together (JP2016-150547A). However, a resin composition used for that technology is a polyether ether ketone composition or an alloy composition of polyether ether ketone and polyether imide, and an alloy resin composition of polyether ether ketone and polyphenylene sulfide is not adopted.

In addition, there is a report that addition of polyether imide to an alloy composition of polyether ether ketone and polyphenylene sulfide enhances all of the tensile strength, impact resistance, and heat distortion temperature of the composition (CN101668814A), but the literature does not describe the composition as having better metal bonding performance than polyether ether ketone monomers.

### SUMMARY

We discovered that an alloy polymer formed of (I) at least one of polyether ketone, polyether ether ketone, and polyether ketone ketone and (II) polyphenylene sulfide has better metal bonding properties than component (I) or component (II) alone.

We thus provide:

1. A resin composition for metal bonding, characterized in that the resin composition includes a component (I) and a component (II);

wherein component (I) is at least one selected from polyether ketone, polyether ether ketone, and polyether ketone ketone; and

wherein component (II) is polyphenylene sulfide.

2. The resin composition for metal bonding according to 1, wherein the addition amount of component (II) is 1 to 9900 parts by weight with respect to 100 parts by weight of component (I).

3. The resin composition for metal bonding according to 1, further including a component (III), which is at least one selected from polyether imide, polyimide, polyamide imide, and polysulfone resins.

4. The resin composition for metal bonding according to 3, wherein the addition amount of component (III) is 0.1 to 20 parts by weight with respect to a total of 100 parts by weight of components (I) and (II).

5. The resin composition for metal bonding according to 4, wherein the addition amount of component (III) is 0.1 parts by weight or more and less than 3 parts by weight with respect to a total of 100 parts by weight of components (I) and (II).

6. The resin composition for metal bonding according to 1, further including an inorganic filler (IV), wherein the addition amount of the inorganic filler (IV) is 5 to 300 parts by weight with respect to a total of 100 parts by weight of components (I) and (II).

7. The resin composition for metal bonding according to 6, wherein the inorganic filler (IV) is at least one selected from glass fiber, carbon fiber, glass beads, mica films, calcium carbonate, magnesium carbonate, silica, talc, and wollastonite.

8. The resin composition for metal bonding according to 2, wherein the addition amount of component (II) is 1 part by weight or more and less than 66.7 parts by weight with respect to 100 parts by weight of component (I).

9. The resin composition for metal bonding according to 8, wherein an average size of dispersed particles of component (II) is 1.0 μm or less.

10. The resin composition for metal bonding according to 2, wherein the addition amount of component (II) is 150 parts by weight or more and 9900 parts by weight or less with respect to 100 parts by weight of component (I).

11. The resin composition for metal bonding according to 10, wherein a size of dispersed particles of component (I) is 5.0 μm or less.

12. The resin composition for metal bonding according to 2, wherein the addition amount of component (II) is 66.7 parts by weight or more and less than 150 parts by weight with respect to 100 parts by weight of component (I).

13. The resin composition for metal bonding according to 12, containing at least component (II) in a dispersion phase whose size of dispersed particles is 1.0 μm or less.

14. A molded article formed by bonding the resin composition for metal bonding according to any one of 1 to 13 and a metal.

15. A method of producing the molded article according to 14, the method comprising: heat-melting the resin composition for metal bonding according to any one of 1 to 13;

injection-molding the resulting resin composition together with a metal preliminarily placed in a mold; and

hardening the resulting product at a mold temperature of 120 to 250° C.

The resin composition for metal bonding has excellent metal bonding properties, and is applicable for use in not only automobile parts that require the composition to be bonded with metal, but also electronic products such as laptop computers and mobile phones.

### BRIEF DESCRIPTION OF THE DRAWINGS

FIG. 1 is a front view of a molded article of metal and resin bonded together.

FIG. 2 is a side view of a molded article of metal and resin bonded together.

### DETAILED DESCRIPTION

Below, examples will be described.

1. Metal Materials

This disclosure relates to a resin composition for metal bonding, and the material of the metal is not limited to a particular one and, for example, gold, platinum, silver, aluminum, magnesium, titanium, iron, tin, zinc, lead, chromium, manganese, copper, stainless steel, cobalt, alloys of these materials and the like all fall within the scope of protection. A piece of the metal is surface-treated, the metal is preliminarily placed in a mold, and injection molding is carried out using the resin for metal bonding to allow the resin to intrude into the pores or concavo-convex structure of the surface of the metal so that physical bonding can be formed. For metal surface treatment, the metal surface may be corroded using a chemical reagent to generate micropores or a concavo-convex structure, micropores may be formed by anodic oxidation, surface micropores may be formed by plating, or the metal surface may be further irradiated with a laser for etching treatment. In this regard, the resin composition may be used for a chemical bonding technology such that the metal is further surface-treated for activation using a chemical reagent, followed by using the above-mentioned injection molding method to form the resin and the metal into a film through chemical reaction.

The metal surface-treatment method may be a treatment method used for NMT (Nano Molding Technology), for example, a metal surface treatment technology such as the T-treatment (T is the initial letter of Taiseiplas) method developed by Taiseiplas co., ltd., the TRI-treatment method developed by Toadenka Co., Ltd., or the C-treatment method developed by Nihon Corona Kogyo K.K. Examples of corrosive liquids used for the corrosion with a chemical reagent include alkaline aqueous solutions (pH>7), acidic aqueous solutions (pH<7), nitrogen-containing compound aqueous solutions and the like. The alkaline aqueous solution may be an aqueous solution of sodium hydroxide, potassium hydroxide, sodium carbonate or the like. The acidic aqueous solution may be an aqueous solution of hydrochloric acid, sulfuric acid, nitric acid, hydrofluoric acid or the like. The nitrogen-containing compound may be ammonia, hydrazine, or water-soluble amine. The water-soluble amine may be methylamine, dimethylamine, trimethylamine, ethylamine, diethylamine, triethylamine, ethylenediamine, propylamine, ethanolamine, diethanolamine, triethanolamine, aniline, or any other amine compound.

The metal surface anodic oxidation is a method in which, using metal as an anode, an oxide film is formed on the metal surface through the electrical current action in an electrolyte solution. For example, water-soluble ammonia can be used as an electrolyte solution for anodic oxidation of a metal surface.

The chemical reagent and used to allow a coated film having reaction activity to be formed between the metal and the resin may be a compound such as ammonia, hydrazine, water-soluble amine, or a triazinethiol derivative.

Specific examples of the triazinethiol derivatives include triazinethiol derivative salts such as 1,3,5-triazine-2,4,6-trithiol (TT), 1,3,5-triazine-2,4,6-trithiolmonosodium (TTN), 1,3,5-triazine-2,4,6-trithioltriethanolamine (F-TEA), 6-anilino-1,3,5-triazine-2,4-dithiol (AF), 6-anilino-1,3,5-triazine-2,4-dithiolmonosodium (AFN), 6-dibutylamino-1,3,5-triazine-2,4-dithiol (DB), 6-dibutylamino-1,3,5-triazine-2,4-dithiolmonosodium (DBN), 6-diallylamine-1,3,5-triazine-2,4-dithiol (DA), 6-diallylamine-1,3,5-triazine-2,4-dithiolmonosodium (DAN), 1,3,5-triazine-2,4,6-trithiol-di(tetrabutylammonium salt) (F2A), 6-dibutylamino-1,3,5-triazine-2,4-dithiol-tetrabutylammonium salt (DBA), 6-dithiooctylamino-1,3,5-triazine-2,4-dithiol (DO), 6-dithiooctylamino-1,3,5-triazine-2,4-dithiolmonosodium (DON), 6-dilauroylamino-1,3,5-triazine-2,4-dithiol (DL), 6-dilauroylamino-1,3,5-triazine-2,4-dithiolmonosodium (DLN), 6-stearylamino-1,3,5-triazine-2,4-dithiol (ST), 6-stearylamino-1,3,5-triazine-2,4-dithiolmonopotassium (STK), 6-oleylamino-1,3,5-triazine-2,4-dithiol (DL), and 6-oleylamino-1,3,5-triazine-2,4-dithiolmonopotassium (OLK).

Examples of such a method of forming micropores by plating a metal surface include a method in which, on the surface of metal, another kind of metal is deposited by electrical treatment, or a method in which a deposited layer is formed by chemical treatment, and the deposit layer may be metal such as gold, silver, nickel, or chromium.

Laser metal surface etching may be a technology in which a laser is used to etch micropores in the surface of metal such as the DLAMP technology developed by Daicel Corporation and Daicel Polymer Ltd. in Japan.

Such a nanolevel concavo-convex structure of a metal surface is such micronlevel to nanolevel pores present in a metal surface as can be observed using a scanning electron microscope. The pores preferably have an average pore size of 10 to 100 nm, more preferably 10 to 80 nm.

2. Component (I)

Component (I) used for the resin composition for metal bonding is at least one selected from polyether ketone, polyether ether ketone, and polyether ketone ketone.

A typical repeating unit in the chemical structure of polyether ketone is represented by formula (1), and the repeating unit represented by formula (1) is 70 mol % or more of the polyether ketone polymer, more preferably 90 mol % or more.

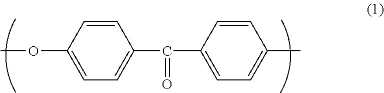

A typical repeating unit in the chemical structure of polyether ether ketone is represented by formula (2), and the repeating unit represented by formula (2) is 70 mol % or more of the polyether ether ketone polymer, more preferably 90 mol % or more. For example, VICTREX (trademark) PEEK manufactured by VICTREX plc, Ketaspire (trademark) and Avaspire (trademark) manufactured by SOLVAY, VESTAKEEP (registered trademark) manufactured by Evonik Industries AG, ZYPEEK (registered trademark) manufactured by Jilin Zhongyan High Performance Plastic Co., Ltd., “PFLUON (registered trademark) PEEK” manufactured by Zhejiang PFLUON Chemical Co., Ltd. and the like can be used.

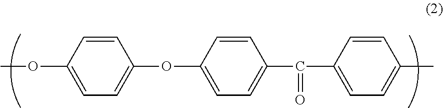

A typical repeating unit in the chemical structure of polyether ketone ketone is represented by formula (3), and the repeating unit represented by formula (3) is 70 mol % or more of the polyether ketone ketone polymer, more preferably 90 mol % or more.

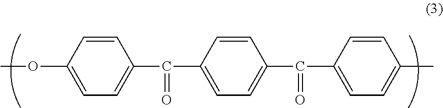

Component (I) is preferably polyether ketone, polyether ether ketone, or polyether ketone ketone having good flowability, preferably polyether ketone, polyether ether ketone, or polyether ketone ketone having a melt volume flow rate (MVR) of 5 cm³/10 min or more, more preferably 15 cm³/10 min or more, most preferably 60 cm³/10 min or more, as measured using a melt indexer at 380° C. under 5 Kgf load test conditions. On the other hand, the polyether ketone, polyether ether ketone, or polyether ketone ketone preferably has a melt volume flow rate (MVR) of 300 cm³/10 min or less to retain the toughness of the resin composition for metal bonding.

3. Component (II)

Component (II) used for the resin composition for metal bonding is polyphenylene sulfide. The polyphenylene sulfide polymer is a polymer having a repeating unit represented by formula (4), and the repeating unit represented by formula (4) is 70 mol % or more of the polyphenylene sulfide polymer, more preferably 90 mol % or more. For example, TORELINA (registered trademark) manufactured by Toray Industries, Inc., Ryton (registered trademark) manufactured by SOLVAY, SUPEC (registered trademark) manufactured by General Electric Co. in the U.S.A., FORTRON (registered trademark) manufactured by Ticona in the U.S.A. and the like can be used.

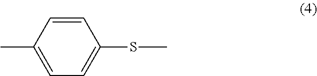

In the polyphenylene sulfide polymer, a repeating unit(s) other than the repeating unit represented by (4) is/are one or more selected from the repeating units having structure (5), (6), (7), (8), (9), (10), or (11).

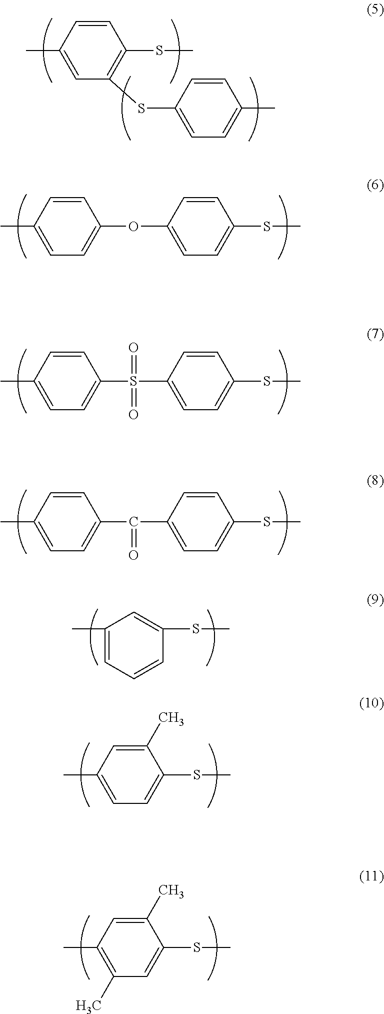

When the polyphenylene sulfide polymer has one or more of the above-mentioned repeating units (5) to (11), the polyphenylene sulfide polymer has a low melting point and is more advantageous in molding. At the same time, the crystallization performance decreases and, accordingly, the molding shrinkage of the molded article decreases.

The polyphenylene sulfide polymer more preferably has a high melt index so that the polymer can obtain good flowability. For example, the melt index is preferably 200 g/10 minutes or more at 315.5° C. at 5 Kgf, more preferably 500 g/10 minutes or more, and in addition, preferably 5000 g/10 minutes or less to retain the resin composition for metal bonding.

In addition, a mixture composed of different kinds of polyphenylene sulfide having different chemical structures is preferably used as polyphenylene sulfide to achieve a good balance among flowability, toughness, and modulus.

The polyphenylene sulfide is not limited to any method of production. The polyphenylene sulfide polymers having the above-mentioned structures (5) to (11) can be produced by the method of obtaining high flowability described in JP45-3368B or the method of obtaining low flowability described in JP52-12240B and the like. A difference between the former method and the latter method depends on whether alkali metal carboxylate as a polymerization auxiliary agent is present in the polymerization system. In the former method, alkali metal carboxylate is not added to the polymerization system, and the flowability is high. In the latter method, alkali metal carboxylate is added to the polymerization system, and the flowability is low and accordingly advantageous for the toughness of the resin. Because of this, using a combination of polyphenylene sulfide polymers produced by the two kinds of methods can achieve a good balance between the flowability and toughness of the polyphenylene sulfide resin.

In this regard, endcapping the polyphenylene sulfide polymer produced as above makes it possible to obtain a polyphenylene sulfide polymer having lower chlorine content. For example, endcapping treatment with 2-mercaptobenzimidazole under alkaline conditions makes it possible to obtain an endcapped polyphenylene sulfide polymer having lower chlorine content.

4. Formulation Ratios of Components (I) and (II)

The addition amount of component (II) is preferably 1 to 9900 parts by weight with respect to 100 parts by weight of component (I). It is necessary to inhibit shrinkage of the resin that has intruded into the micropores or concavo-convex structure of the metal surface. To achieve this, resin components (I) and (II) are mixed to mutually inhibit crystallization of the two resin components. Component (II) is preferably 5 parts by weight or more, more preferably 10 parts by weight or more, most preferably 15 parts by weight or more, with respect to 100 parts by weight of component (I). On the other hand, the addition amount of component (II) is preferably 1900 parts by weight or less, more preferably 900 parts by weight or less, most preferably 570 parts by weight or less, with respect to 100 parts by weight of component (I).

5. Component (III)

Component (III) used for the resin composition for metal bonding is at least one of polyether imide, polyimide, polyamide imide, or a polysulfone resin.

The polyether imide is a polymer having a repeating unit represented by formula (12), and the repeating unit represented by formula (12) is 70 mol % or more of the polyether imide polymer, more preferably 90 mol % or more.

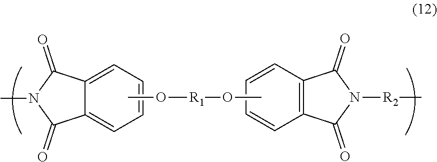

In formula (12), R₁ is a C₆-C₃₀ bivalent aromatic moiety, and R₂ is a bivalent organic group selected from the group consisting of C₆-C₃₀ bivalent aromatic moieties, C₂-C₂₀ alkylene groups, C₂-C₂₀ cycloalkylene, and polyorganosiloxane groups endcapped with a C₂-C₈ alkylene group. The R₁ and R₂ are preferably such chemical groups as below-mentioned.

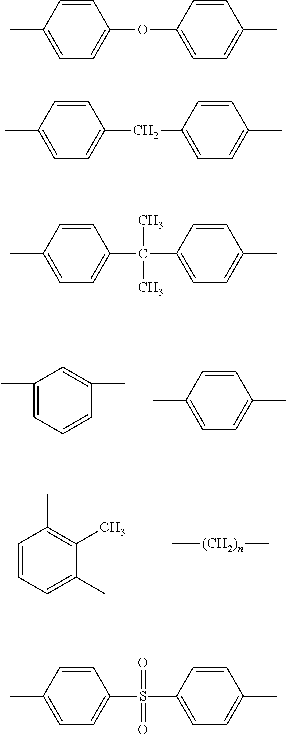

The polyimide is a polymer having a repeating unit represented by formula (13), and the repeating unit represented by formula (13) is 70 mol % or more of the polyimide polymer, more preferably 90 mol % or more.

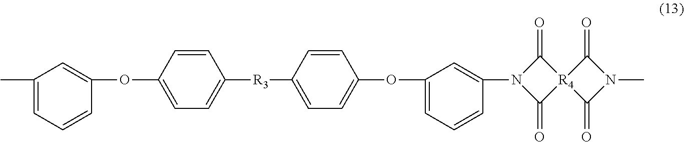

In formula (13), R₃ is a direct bond, —SO₂—, —CO—, —C(CH₃)₂—, C(CF₃)₂—, or —S—. In addition, R₄ is one or more selected from the following structures.

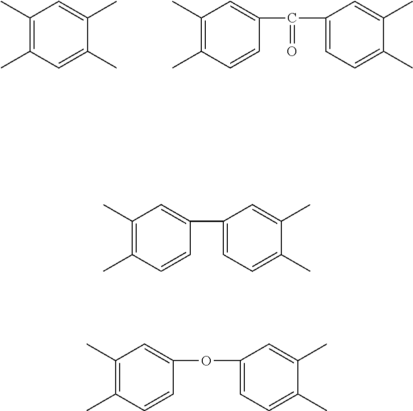

The polyamide imide is a polymer having a repeating unit represented by formula (14), and the repeating unit represented by formula (14) is 70 mol % or more of the polyamide imide polymer, more preferably 90 mol % or more.

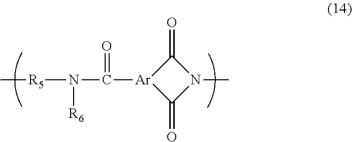

In formula (14), R₅ is a bivalent aromatic and/or aliphatic group, R₆ is a hydrogen atom, methyl, or phenyl, and Ar is a trivalent aromatic group containing at least one six-membered ring.

More specifically, the repeating structure unit represented by formula (14) can be polymerized together with the repeating structure unit represented by formula(e) (15) and/or (16).

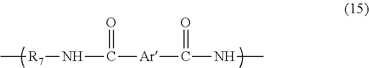

The above description of R₅ applies to R₇, and Ar′ represents a bivalent aromatic group or bivalent alicyclic group containing one or more six-membered carbon rings.

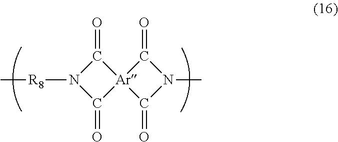

The above description of R₅ applies to R₈, and Ar″ represents a tetravalent aromatic group that contains one or more six-membered carbon rings and is linked to a carbonyl group.

The imide bond structures of structure units (14) and (16) can have a pre-cyclized structure represented by structure unit (17).

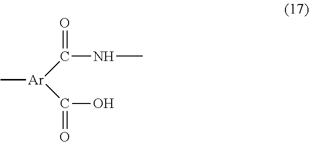

The polysulfone resin is a polymer having the repeating unit represented by formula (18) or (19), and the repeating unit represented by formula (18) or (19) is 70 mol % or more of the polysulfone resin, more preferably 90 mol % or more.

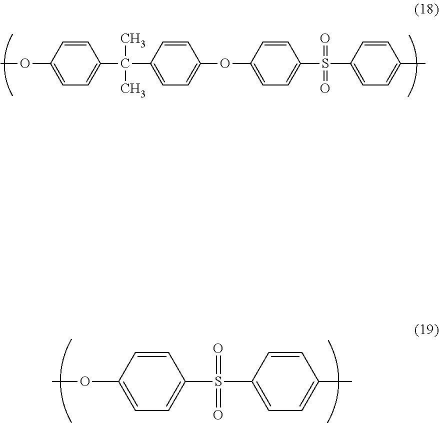

6. Formulation Ratio of Component (III)

The addition amount of component (III) is preferably 0.1 to 20 parts by weight with respect to 100 parts by weight of components (I) and (II). Component (III) can affect the mixing properties of components (I) and (II) and, in addition, plays a role that inhibits crystallization of components (I) and (II) and, accordingly, the addition amount of component (III) is preferably 10 parts by weight or less, more preferably 5 parts by weight or less, most preferably less than 3 parts by weight, and in addition, preferably 0.5 parts by weight or more, more preferably 1 part by weight or more, with respect to 100 parts by weight of components (I) and (II).

7. Inorganic Filler (IV) and Formulation Ratio Thereof

The formulation ratio of inorganic filler (IV) is preferably 5 to 300 parts by weight with respect to 100 parts by weight of components (I) and (II). Within this addition amount range, the resin composition for metal bonding can decrease shrinkage factor and impart good flowability to the resin composition. The addition amount of inorganic filler (IV) is preferably 10 parts by weight or more, more preferably 20 parts by weight or more, most preferably 30 parts by weight or more with respect to 100 parts by weight of components (I) and (II). In addition, the addition amount is preferably 200 parts by weight or less, more preferably 100 parts by weight or less, most preferably 70 parts by weight or less with respect to 100 parts by weight of components (I) and (II).

The inorganic filler is a filler used for resins adopted in conventional technologies. Examples include glass fiber, carbon fiber, potassium titanate whisker, zinc whisker oxide, aluminum borate whisker, aramid fiber, alumina fiber, silicon carbide fiber, ceramic fiber, asbestos fiber, gypsum fiber, metal fiber, wollastonite, zeolite, sericite, kaolin, mica, talc, clay, pyrophyllite, bentonite, montmorillonite, hectorite, synthetic mica, asbestos, graphite, aluminosilicate, alumina, silica, magnesium oxide, zirconia, titanium oxide, iron oxide, calcium carbonate, magnesium carbonate, dolomite, calcium sulfate, barium sulfate, magnesium hydroxide, calcium hydroxide, aluminium hydroxide, glass beads, ceramic beads, boron nitride, silicon carbide, and wollastonite. The inorganic filler may have a hollow structure, and furthermore, two or more inorganic fillers selected from these may be used in combination.

In particular, considering the low molding shrinkage factor and flowability comprehensively, the inorganic filler is preferably at least one of glass fiber and carbon fiber to obtain the resin composition for metal bonding that has good performance. The glass fiber is not limited to a particular one, and may be glass fiber adopted in conventional technologies. Glass fiber may be fiber in the shape of a chopped strand cut in a fixed length, coarse sand, ground fiber and the like. In general, glass fiber for use preferably has an average diameter of 5 to 15 μm. When a chopped strand is used, the length is not limited to a particular one, and a fiber having such a standard length of 3 mm as applied in an extrusion kneading operation is preferably used.

On the other hand, the inorganic filler is preferably at least one of glass beads, mica, calcium carbonate, magnesium carbonate, silica, talc, and wollastonite to obtain good product appearance.

The average diameter of the inorganic filler is not limited to a particular one, and preferably 0.001 to 20 μm and, in this range, good flowability and good appearance can be obtained.

To obtain better performance, the inorganic filler is preferably an inorganic filler pretreated with a coupling agent such as an isocyanate compound, organosilane compound, organic titanate compound, organic borane compound, or epoxy compound.

8. Sizes of Dispersed Particles of Components (I) and (II)

The formulation ratios of components (I) and (II) vary depending on the state of dispersion of each component. In this regard, the form of dispersion can be changed also by addition of component (III). When the addition amount of component (II) is 1 part by weight or more and less than 66.7 parts by weight with respect to 100 parts by weight of component (I), the structure is formed such that component (I) is a sea phase, and component (II) is an island phase. In this example, component (II) having a smaller size of dispersed particles has higher metal bonding performance, and accordingly is preferable. In this example, component (II) has an average size of dispersed particles of preferably 1.0 μm or less, more preferably 0.50 μm or less, still more preferably 0.40 μm or less, most preferably 0.2 μm or less.

In this regard, when component (II) is 150 part by weight or more and 9900 parts by weight or less with respect to 100 parts by weight of component (I), the structure is formed such that component (I) is an island phase, and component (II) is a sea phase. In this example, component (I) having a smaller size of dispersed particles has higher metal bonding performance, and accordingly is preferable. In this example, component (I) has an average size of dispersed particles of preferably 5.0 μm or less, more preferably 3.0 μm or less, still more preferably 2.0 μm or less.

In this regard, when component (II) is 66.7 parts by weight or more and less than 150 parts by weight with respect to 100 parts by weight of component (I), the structure is formed such that a state in which component (I) is a sea phase, and component (II) is an island phase, and a state in which component (I) is an island phase, and component (II) is a sea phase simultaneously exist, and in this example, the size of dispersed particles of component (II) as an island phase is small, and the metal bonding performance tends to be high. Because of this, the dispersion phase of contained component (II) preferably has a size of dispersed particles of 1.0 μm or less, component (II) preferably has a size of dispersed particles of 1.0 μm or less, the size of dispersed particles is more preferably 0.6 μm or less, the size of dispersed particles is still more preferably 0.40 μm or less, and the size of dispersed particles is most preferably 0.3 μm or less.

The size of dispersed particles of each component can be measured by the following method. The resin composition for metal bonding is cut using an automatic sheet cutting machine, followed by observation using the JEM-2100 transmission electron microscope manufactured by JEOL Ltd. Then, the obtained electron micrograph was processed using an image analysis software, Image-ProPlus, from Media Cybernetics, Inc. to calculate an area of a dispersion phase of 100 particles, the area is converted into an area of a circle, and then the diameter is calculated, to thereby obtain the average size of dispersed particles. However, when component (II) is 150 parts by weight or more and 900 parts by weight or less with respect to 100 parts by weight of component (I), 100 particles of a PPS dispersion phase are randomly selected from the obtained electron micrograph, and the smallest size of dispersed particles is measured.

9. Other Additives

The resin composition for metal bonding may further contain, in addition to components (I) to (III), another thermoplastic polymer, for example, polyamide, polyethylene, polypropylene, polyester, polycarbonate, polyphenylene ether, a liquid crystal polymer, ABS resin, SAN resin, polystyrene, or teflon. To improve the toughness of the resin composition for metal bonding, a (co)modified polyolefin polymer obtained by polymerizing an olefinic compound and/or a conjugated diene compound is preferable.

In this regard, an antioxidant may be added to the resin composition for metal bonding to the extent that the desired effects are not impeded. The addition can further enhance the heat resistance and thermal stability of the resin composition. The antioxidant preferably contains at least one selected from phenolic antioxidants and phosphoric antioxidants. When a phenolic antioxidant and a phosphoric antioxidant are used in combination, the combined use of the two is preferable because the heat resistance and thermal stability can be effectively retained.

As a phenolic antioxidant, a hindered phenolic compound is preferably used. Specific examples include triethyleneglycolbis(3-tert-butyl-(5-methyl-4-hydroxybenzyl)propionate), N,N′-hexamethylenebis(3,5-di-tert-butyl-4-hydroxy-cinnamamide hydride), tetra(methylene-3-(3 ‘,5′-di-tert-butyl-4′-hydroxybenzyl)propionate)methane, pentaerythritoltetra(3-(3’,5′-di-tert-butyl)-4′-hydroxybenzyl)propionate), 1,3,5-tri(3,5-di-tert-butyl-4-hydroxybenzyl)-s-triazine-2,4,6-(1H,3H,5H)-triketone, 1,1,3-tri(2-methyl-4-hydroxy-5-tert-butylphenyl)butane, 4,4′-butylenebis(3-methyl-6-tert-butylphenyl), n-octadecyl-3-(3,5-di-tert-butyl-4-hydroxyphenyl)propionate, 3,9-bis(2-(3-(3-tert-butyl-4-hydroxy-5-methylphenyl)propionyloxy)-1,1-dimethylethyl)-2,4,8,10-tetraoxasp,5)undecane, trimethyl-2,4,6-tri-(3,5-di-tert-butyl-4-hydroxybenzyl)benzene and the like. Among these, preferable are ester type polymer hindered phenol types, and specifically, it is preferable to use tetra(methylene-3-(3′,5′-di-tert-butyl-4′-hydroxybenzyl)propionate)methane, pentaerythritoltetra(3-(3′,5′-di-tert-butyl)-4′-hydroxybenzyl)propionate), 3,9-bis(2-(3-(3-tert-butyl-4-hydroxy-1-methylphenyl)propionyloxy)-1,1-dimethylethyl)-2,4,8,10-tetraoxaspiro(5,5)undecane or the like.

Examples of phosphoric antioxidants include, bis(2,6-di-tert-butyl-4-methylphenyepentaerythritol-diphosphite, bis(2,4-di-tert-butylphenyl)pentaerythritol-diphosphite, bis(2,4-dicumylphenyl)pentaerythritol-diphosphite, tri(2,4-di-tert-butylphenyl)phosphite, tetra(2,4-di-tert-butylphenyl)-4,4′-diphenylenephosphite, distearoylpentaerythritol-diphosphite, triphenylphosphite, 3,5-dibutyl-4-hydroxybenzylphosphatediethyl ester and the like.

The addition amount of the antioxidant is preferably 0.01 to 3 parts by weight, more preferably 0.05 to 2 parts by weight, most preferably 0.1 to 1 part by weight, with respect to 100 parts by weight of relative components (I) and (II).

In this regard, release agents (montanoic acid, metal salts thereof, esters thereof, and half esters thereof, stearyl alcohol, amide stearate, amide, biurea, polyethylene wax or the like, among which amide is preferable because amide decreases gas generation in molding processes), pigments (cadmium sulfide, phthalocyanine, colored carbon black masterbatch or the like), dyes (aniline black or the like), crystallizing agents (talc, titanium dioxide, kaolin, clay or the like), plasticizers (octyl-p-hydroxybenzoate, N-butylbenzenesulfoneamide or the like), antistatistic agents (alkylsulphate type anion antistatistic agents, quaternary ammonium type cation antistatistic agents, nonionic type antistatistic agents such as polyoxyethylene sorbitan monostearate, or glycinebetaine amphoteric antistatistic agents), flame retardants (for example, red phosphorus, phosphate ester, melamine cyanurate, magnesium hydroxide, aluminium hydroxide, polyammonium phosphate, brominated polystyrene, brominated polyphenylene ether, polycarbonate bromide, brominated epoxy resin, or combinations of these bromine-containing flame retardants and antimony trioxide) and the like can further be used, and one or more can be selected from these and used in combination.

10. Production of Metal Bonding Composition

The resin composition for metal bonding can be produced from main components (I) and (II) and additional components (III) and (IV), if necessary, using a conventional melt-kneading machine, for example, a single screw or twin screw extruder, Banbury mixer, or kneader in accordance with the melt-kneading method corresponding to the kneading machine.

11. Production of Metal-Bonded Molded Article

The resin composition for metal bonding is heat-melted and injection-molded together with metal piece preliminarily placed in a mold. More specifically, the method is as below-mentioned.

A metal piece is preliminarily inserted into a mold, and the resin composition for metal bonding is injection-molded to thereby obtain a metal-bonded molded article. The mold temperature is preferably 120° C. to 250° C., and the resin composition for metal bonding melted under the condition of 120° C. or more can intrude into the micropores or concavo-convex structure of the metal surface. The mold temperature is preferably 130° C. or more, more preferably 140° C. or more, and, in a formulation method in which the formulation ratio of component (I) is larger than that of component (II), the mold temperature is preferably 180° C. or more, most preferably 200° C. or more. On the other hand, when the mold temperature is 250° C. or less, the resin composition for metal bonding can be hardened in a mold, and the mold temperature is preferably 240° C. or less, more preferably 230° C. or less. When the molding is carried out by a formulation method in which the formulation ratio of component (II) is larger than that of component (I), the mold temperature is preferably 170° C. or less, most preferably 160° C. or less.

The resin composition for metal bonding has high bonding strength, and is applicable for use in automobile parts that require the composition to be bonded with metal and in frames of electronic products such as laptop computers and mobile phones.

Below, our resin compositions, products and methods will further be described with reference to specific Examples. The following Examples represent implementation of the technical means, and detailed examples and specific operation processes are described therein, but the scope of protection of this disclosure is not limited to the following Examples.

### EXAMPLES

1. Metal

Aluminum piece A6061 (45 mm*10 mm*1.5 mm): Kunshan Xinda Jinxing Co., Ltd.

Stainless steel SUS361 (45 mm*10 mm*1.5 mm): Shanghai Jingjin Maoyi Co., Ltd.

Brass (45 mm*10 mm*1.5 mm): Shanghai Jingjin Maoyi Co., Ltd.

Company that T-treats the aluminum pieces at request: Shenzhen Baoyuanjin Co., Ltd.

Company that TRI-treats the aluminum plates at request: Shenzhen Jinhong Xin Keji Co., Ltd.

Company that plates stainless steel and brass at request: Shenzhenshi Rui Changsheng Jingmi Keji Co., Ltd.

2. Raw Materials of Resin Composition

Polyether Ether Ketone, PEEK (1): VICTREX (trademark) 450PF

Polyether Ether Ketone, PEEK (2): PFLUON PEEK (registered trademark) 8800G (a melt volume flow rate (MVR) of 70 cm³/10 min), manufactured by Zhejiang PFLUON Chemical Co., Ltd.

Polyether Ether Ketone, PEEK (3): PFLUON PEEK (registered trademark) 8900G (a melt volume flow rate (MVR) of 120 cm³/10 min), manufactured by Zhejiang PFLUON Chemical Co., Ltd.

Polyphenylene Sulfide, PPS: TORELINA (registered trademark) M2888, from Toray Industries, Inc.

Polyether Imide, PEI: SABIC ULTEM (trademark) PEI1010,

Polysulfone Resin, PES: F2150, from Jiangmen City Yu Ju New Material Co., Ltd.

Glass Fiber: CSG 3PA-830, from Nitto Boseki Co., Ltd.

3. Metal Bonding Properties of Resin Composition

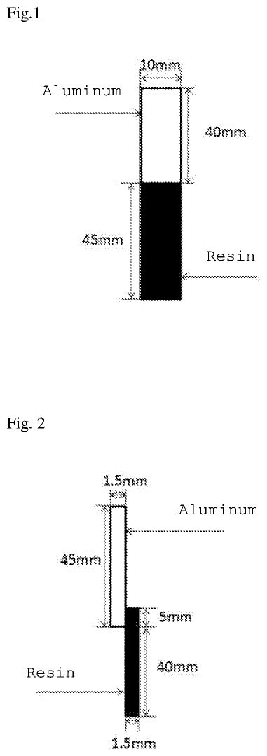

The shape of a molded article obtained by injection-molding the resin composition and metal that were bonded is shown in FIG. 1. After molding, the articles were annealed under 130° C. conditions for one hour in a formulation method in which the PPS content was higher. The articles were annealed under 170° C. conditions for one hour in a formulation method in which the PEEK content was higher and in a formulation method in which the PEEK content was equal to the PPS content. After the articles were left to stand for 24 hours, the articles were measured for shear strength using the AG-IS1KN device manufactured by Shimadzu Corporation in Japan under measurement conditions: a tension rate of 5 mm/min and a fixture distance of 3 mm, in an atmosphere having a temperature of 23° C. and a humidity of 50% RH.

4. Flexural Performance

In Examples and Comparative Examples shown in Table 6, the bending performance is based on the flexural modulus and flexural strength obtained by carrying out measurement on the molded articles which were molded using the NEX-50 molding machine manufactured by Nissei Limited under 140° C. mold temperature conditions in accordance with the IS0178 standard.

5. Size of Dispersed Particles of Each Component

An automatic slicer was used to partially slice the resin of a molded article in which a resin composition and T-treated metal were bonded, and the resin was further observed using the JEM-2100 transmission electron microscope manufactured by JEOL Ltd. The observation results were processed using a graphics processing software from Media Cybernetics, Inc., an area of 100 particles in the dispersion phase was converted into an area of a circle, and then the diameter was calculated, to thereby obtain the average size of dispersed particles. However, the results of Examples 23 to 28 are the smallest sizes of dispersed particles calculated from the sizes of 100 particles of PPS dispersion phase randomly selected from the electron micrograph.

### Examples 1 to 32 and Comparative Examples 1 to 6

The raw materials were weighed as shown in Tables 1 to 6. The materials were made into pellets using the TEX30a twin screw extruder (L/D=45.5) manufactured by Japan Steel Works, Ltd., wherein the twin screw extruder had two sets of supplying devices with a weighing device and was equipped with an evacuation device. After the raw materials other than glass fiber were mixed in a high-speed mixer, the resulting mixture was fed through the main supply port of the extruder, the glass fiber was fed through the side supply port of the extruder, the temperature of the extruder was set as shown in Tables 1 to 6, the resulting resin composition for metal bonding was dried for 12 hours in an oven at 130° C., then the above-mentioned treated metal was placed in a mold, and the materials and metal were injection-molded using the NEX-50 molding machine from Nissei Limited to obtain a molded article of the resin composition and metal that were bonded. The molding temperatures and mold temperatures are shown in Tables 1 to 6.

TABLE 1

| | | | | | | | Comparative |
|---|---|---|---|---|---|---|---|
| | | Example 1 | Example 2 | Example 3 | Example 4 | Example 5 | Example 1 |
| PEEK (1) | | 80 | 80 | 80 | 80 | 80 | 100 |
| PPS | | 20 | 20 | 20 | 20 | 20 | |
| PEI | | | 2.4 | 3 | 6 | 9 | |
| Extrusion Temperature (° C.) | | 380 | 380 | 380 | 380 | 380 | 380 |
| Molding Temperature (° C.) | | 370 | 370 | 370 | 370 | 370 | 370 |
| Mold Temperature (° C.) | | 160 | 160 | 160 | 160 | 160 | 160 |
| Shear Strength | T-treated | 4 | 9 | 8 | 6 | 4 | 2 |
| (MPa) | Aluminium | | | | | | |

As understood from a comparison between Example 1 and Comparative Example 1, addition of PEEK and PPS increased the shear strength. As understood from a comparison between Example 1 and Examples 2 to 4, addition of PEI to the formulation of PEEK (1) and PPS at 80:20 increased the shear strength.

TABLE 2

| | | | | Comparative | | | | Comparative |
|---|---|---|---|---|---|---|---|---|
| | | Example 6 | Example 7 | Example 2 | Example 8 | Example 9 | Example 10 | Example 3 |
| PEEK (1) | | 80 | 80 | 100 | 98 | 80 | 80 | 100 |
| PPS | | 20 | 20 | | 2 | 20 | 20 | |
| PEI | | | 3 | | | | 3 | |
| GF | | 42.9 | 42.9 | 42.9 | 42.9 | 42.9 | 42.9 | 42.9 |
| Extrusion Temperature (° C.) | | 380 | 380 | 380 | 380 | 380 | 380 | 380 |
| Molding Temperature (° C.) | | 370 | 370 | 370 | 370 | 370 | 370 | 370 |
| Mold Temperature (° C.) | | 160 | 160 | 160 | 220 | 220 | 220 | 220 |
| Shear Strength | T-treated | 5 | 10 | 0 | 19 | 22 | 25 | 12 |
| (MPa) | Aluminium | | | | | | | |

As understood from Comparative Example 2, the method of formulating the glass-fiber-reinforced pure PEEK (1) at a mold temperature of 160° C. failed to achieve metal bonding. As understood from Example 6, addition of PPS achieved metal bonding. As understood from Example 7, addition of PEI increased the shear strength.

From a comparison between Examples 6 and 7 and Examples 9 and 10, it is understood that increasing the mold temperature to 220° C. increased the shear strength.

TABLE 3

| | | | | | | | | Comparative |
|---|---|---|---|---|---|---|---|---|
| | | Example 11 | Example 12 | Example 13 | Example 14 | Example 15 | Example 16 | Example 4 |
| PEEK (2) | | 80 | 80 | 80 | 80 | 80 | 80 | 100 |
| PPS | | 20 | 20 | 20 | 20 | 20 | 20 | |
| PEI | | | 1 | 2 | 3 | 6 | 9 | |
| GF | | 42.9 | 42.9 | 42.9 | 42.9 | 42.9 | 42.9 | 42.9 |
| Extrusion Temperature (° C.) | | 380 | 380 | 380 | 380 | 380 | 380 | 380 |
| Molding Temperature (° C.) | | 380 | 380 | 380 | 380 | 380 | 380 | 380 |
| Mold Temperature (° C.) | | 220 | 220 | 220 | 220 | 220 | 220 | 220 |
| Shear Strength | T-treated | 20 | 23 | 25 | 27 | 22 | 21 | 15 |
| (MPa) | Aluminium | | | | | | | |
| | TRI-treated | 20 | 23 | 27 | 29 | 27 | 24 | 16 |
| | Aluminium | | | | | | | |

| | | | | | | | |
|---|---|---|---|---|---|---|---|
| PPS Average Size of | 0.62 | 0.35 | 0.20 | 0.12 | 0.14 | 0.16 | — |
| Dispersed Particles (μm) | | | | | | | |

As understood from a comparison between Example 11 and Comparative Example 4, the formulation method in which PPS was added to PEEK (2) increased the shear strength. As understood from Examples 11 to 16, addition of PEI to the formulation of PEEK (2) and PPS at 80:20 increased the shear strength. In this regard, addition of PEI decreased the average size of dispersed particles of PPS.

TABLE 4

| | | | | | | | | Comparative |
|---|---|---|---|---|---|---|---|---|
| | | Example 17 | Example 18 | Example 19 | Example 20 | Example 21 | Example 22 | Example 5 |
| PEEK (2) | | 20 | 20 | 20 | 20 | 20 | 20 | |
| PPS | | 80 | 80 | 80 | 80 | 80 | 80 | 100 |
| PEI | | | 1 | 2 | 3 | 6 | 9 | |
| GF | | 42.9 | 42.9 | 42.9 | 42.9 | 42.9 | 42.9 | 42.9 |
| Extrusion Temperature (° C.) | | 330 | 330 | 330 | 330 | 330 | 330 | 330 |
| Molding Temperature (° C.) | | 330 | 330 | 330 | 330 | 330 | 330 | 330 |
| Mold Temperature (° C.) | | 140 | 140 | 140 | 140 | 140 | 140 | 140 |
| Shear Strength | T-treated | 24 | 26 | 28 | 28 | 22 | 21 | 18 |
| (MPa) | Aluminium | | | | | | | |
| | TRI-treated | 21 | 24 | 25 | 25 | 21 | 20 | 17 |
| | Aluminium | | | | | | | |

| | | | | | | | |
|---|---|---|---|---|---|---|---|
| PEEK Average Size of | 3.6 | 2.5 | 1.9 | 1.9 | 2.4 | 2.5 | — |
| Dispersed Particles (μm) | | | | | | | |

As understood from a comparison between Example 17 and Comparative Example 5, using the formulation method in which PEEK (2) was added to PPS increased the shear strength. As understood from Examples 17 to 20, addition of PEI to the formulation of PEEK (2) and PPS at 20:80 increased the shear strength. In this regard, addition of PEI decreased the average size of dispersed particles of PEEK.

TABLE 5

| | | Example | Example | Example | Example | Example | Example | Comparative | Comparative |
|---|---|---|---|---|---|---|---|---|---|
| | | 23 | 24 | 25 | 26 | 27 | 28 | Example 4 | Example 5 |
| PEEK (2) | | 50 | 50 | 50 | 50 | 50 | 50 | 100 | |
| PPS | | 50 | 50 | 50 | 50 | 50 | 50 | | 100 |
| PEI | | | 1 | 2 | 3 | 6 | 9 | | |
| GF | | 42.9 | 42.9 | 42.9 | 42.9 | 42.9 | 42.9 | 42.9 | 42.9 |
| Extrusion Temperature (° C.) | | 370 | 370 | 370 | 370 | 370 | 370 | 380 | 330 |
| Molding Temperature (° C.) | | 380 | 380 | 380 | 380 | 380 | 380 | 380 | 330 |
| Mold Temperature (° C.) | | 160 | 160 | 160 | 160 | 160 | 160 | 220 | 140 |
| Shear Strength | T-treated | 20 | 21 | 23 | 23 | 21 | 20 | 15 | 18 |
| (MPa) | Aluminium | | | | | | | | |
| | TRI-treated | 20 | 21 | 26 | 23 | 21 | 20 | 15 | 17 |
| | Aluminium | | | | | | | | |

| | | | | | | | | |
|---|---|---|---|---|---|---|---|---|
| Smallest Size of Dispersed | 0.52 | 0.37 | 0.21 | 0.23 | 0.23 | 0.23 | — | — |
| Particles of PPS Dispersion | | | | | | | | |
| Phase (μm) | | | | | | | | |

As understood from a comparison between Example 23 and Comparative Examples 4 and 5, the formulation method in which PEEK (2) and PPS are used together increased the shear strength. As understood from Examples 23 to 27, addition of PEI polyether imide to the formulation of PEEK (2) and PPS at 50:50 increased the shear strength. In this regard, addition of PEI decreased the smallest size of dispersed particles of PPS.

TABLE 6

| | | Example | Example | Example | Example | Example | Example | Example | Comparative | Comparative |
|---|---|---|---|---|---|---|---|---|---|---|
| | | 14 | 29 | 20 | 30 | 26 | 31 | 32 | Example 5 | Example 6 |
| PEEK (2) | | 80 | | 20 | | 50 | | | | |
| PEEK (3) | | | 80 | | 20 | | 50 | 80 | | 100 |
| PPS | | 20 | 20 | 80 | 80 | 50 | 50 | 20 | 100 | |
| PEI | | 3 | 3 | 3 | 3 | 3 | 3 | | | |
| PES | | | | | | | | 3 | | |
| GF | | 42.9 | 42.9 | 42.9 | 42.9 | 42.9 | 42.9 | 42.9 | 42.9 | 42.9 |
| Extrusion Temperature (° C.) | | 380 | 380 | 330 | 330 | 370 | 370 | 380 | 330 | 380 |
| Molding Temperature (° C.) | | 380 | 380 | 330 | 330 | 380 | 380 | 380 | 330 | 380 |
| Mold Temperature (° C.) in Metal | | 220 | 220 | 140 | 140 | 160 | 160 | 220 | 140 | 220 |
| Bonding Molding | | | | | | | | | | |
| Shear Strength | TRI-treated | 29 | 31 | 25 | 27 | 23 | 24 | 32 | 17 | 16 |
| (MPa) | Aluminium | | | | | | | | | |
| | Plated Stainless | 30 | 33 | 22 | 25 | 25 | 27 | 35 | 18 | 17 |
| | Steel | | | | | | | | | |
| | Plated Brass | 27 | 28 | 22 | 24 | 24 | 25 | 30 | 17 | 15 |

| | | | | | | | | | |
|---|---|---|---|---|---|---|---|---|---|
| Temperature in Molding of Bending | 140 | 140 | 140 | 140 | 140 | 140 | 140 | 140 | 140 |
| Test Sample (° C.) | | | | | | | | | |
| Bending Modulus (GPa) | 11 | 11 | 12 | 12 | 12 | 12 | 11 | 11 | 11 |
| Bending Strength (MPa) | 235 | 233 | 213 | 209 | 243 | 241 | 238 | 205 | 245 |

As understood from a comparison between Example 14 and Examples 29, between Example 20 and Example 30, and between Example 26 and Example 31, the formulation method in which PEEK (3) having a large melt volume flow rate (MVR) was used increased the shear strength.

1.-15. (canceled)

16. A resin composition for metal bonding comprising a component (I) and a component (II);
wherein said component (I) is at least one selected from polyether ketone, polyether ether ketone, and polyether ketone ketone; and
wherein said component (II) is polyphenylene sulfide.

17. The resin composition according to claim 16, wherein an addition amount of said component (II) is 1 to 9900 parts by weight with respect to 100 parts by weight of said component (I).

18. The resin composition according to claim 16, further comprising a component (III), which is at least one selected from polyether imide, polyimide, polyamide imide, and polysulfone resins.

19. The resin composition according to claim 18, wherein an addition amount of said component (III) is 0.1 to 20 parts by weight with respect to a total of 100 parts by weight of said components (I) and (II).

20. The resin composition according to claim 19, wherein an addition amount of said component (III) is 0.1 parts by weight or more and less than 3 parts by weight with respect to a total of 100 parts by weight of said components (I) and (II).

21. The resin composition according to claim 16, further comprising an inorganic filler (IV), wherein an addition amount of said inorganic filler (IV) is 5 to 300 parts by weight with respect to a total of 100 parts by weight of said components (I) and (II).

22. The resin composition according to claim 21; wherein said inorganic filler (IV) is at least one selected from glass fiber, carbon fiber, glass beads, mica films, calcium carbonate, magnesium carbonate, silica, talc, and wollastonite.

23. The resin composition according to claim 17, wherein an addition amount of said component (II) is 1 part by weight or more and less than 66.7 parts by weight with respect to 100 parts by weight of said component (1).

24. The resin composition according to claim 23, wherein an average size of dispersed particles of said component (II) is 1.0 μm or less.

25. The resin composition according to claim 17, wherein an addition amount of said component (II) is 150 parts by weight or more and 9900 parts by weight or less with respect to 100 parts by weight of said component (I).

26. The resin composition according to claim 25, wherein a size of dispersed particles of said component (I) is 5.0 μm or less.

27. The resin composition according to claim 17, wherein an addition amount of said component (II) is 66.7 parts by weight or more and less than 150 parts by weight with respect to 100 parts by weight of said component (I).

28. The resin composition according to claim 27, wherein the resin composition contains at least dispersed particles of component (II) whose size is 1.0 μm or less.

29. A molded article formed by bonding said resin composition according to claim 16 and a metal.

30. A method of producing the molded article according to claim 29, said method comprising:
heat-melting said resin composition;
injection-molding the resulting resin composition together with a metal piece preliminarily placed in a mold; and
hardening the resulting product at a mold temperature of 120 to −250° C.
